(19) United States
(12) Patent Application Publication
(10) Pub. No.: US 2003/0217921 A1
(43) Pub. Date: Nov. 27, 2003

(54) Gas sensor

(76) Inventors: Toshiyuki Dobashi, Toyota-shi (JP); Rentaro Mori, Kasugai-shi (JP)

Correspondence Address: KENYON & KENYON, 1500 K STREET, N.W., SUITE 700, WASHINGTON, DC, 20005, US

(21) Appl. No.: 10/419,885

(22) Filed: Apr. 22, 2003

(30) Foreign Application Priority Data
May 24, 2002 (JP) 2002-151180

(51) Int. Cl. G01N 27/26

(52) U.S. Cl. 204/424; 204/431

(57) ABSTRACT

A gas sensor includes a sensor element which contains a solid electrolyte, and has a cylindrical shape that is closed at one end and is opened at the other end; and a ceramic heater which is formed into a rod shape, and is inserted and disposed in the sensor element. A peripheral edge of a lower end of the ceramic heater contacts an inner face of a bottom portion of the sensor element. The peripheral edge of the lower end of the ceramic heater has a shape that fits the inner face of the bottom portion of the sensor element at a portion of contact between the sensor element and the ceramic heater.

### INCORPORATION BY REFERENCE

The disclosure of Japanese Patent Application No. 2002-151180 filed on May 24, 2002 including the specification, drawings and abstract is incorporated herein by reference in its entirety.

### BACKGROUND OF THE INVENTION

1. Field of the Invention

The invention relates to a gas sensor using a solid electrolyte which is excellent in ionic conductivity.

2. Description of the Related Art

As a gas sensors which detect a concentration of a specific component contained in gas, for example, an oxygen sensor mounted in an exhaust system of an automobile is known. In a gas sensor of this type, electrodes are provided at both ends of a detecting element containing a solid electrolyte. One of the electrode is exposed to a reference gas, and the other electrode is exposed to a subject gas. Thus, the concentration of the gas is detected by detecting a potential difference between both the electrodes which is generated due to movement of ions in the solid electrolyte.

In these years, many vehicles are provided with an internal combustion engine including an exhaust gas purifying system using oxidation-reduction action of a three-way catalyst. In the exhaust gas purifying system, air-fuel ratio control is performed in order to effectively purify an exhaust gas using the three-way catalyst, and the aforementioned oxygen sensor is mounted in an exhaust system in order to perform the air-fuel ratio control. A oxygen partial pressure in the exhaust gas is detected using the oxygen sensor, and an fuel injection amount is feedback-controlled such that the air-fuel ratio determined based on the result of the detection matches a stoichiometric air-fuel ratio.

FIG. 7 is an enlarged vertical sectional view showing an configuration example of a detecting portion of an oxygen sensor according to the related art. FIG. 8 is a schematic view describing a mechanism by which a concentration of oxygen is detected by the detecting portion. Hereinafter, the structure of the detecting portion of the oxygen sensor and the mechanism by which the concentration of oxygen is detected will be described with reference to these drawings.

First, the structure of the detecting portion of the oxygen sensor will be described with reference to FIG. 7. As shown in FIG. 7, a sensor element 2 has a bottomed cylindrical shape that is closed at a lower end and is opened at an upper end. The sensor element 2 is made mainly of a solid electrolyte 3. As the solid electrolyte 3, zirconia or the like is used. A reference gas chamber 6 into which atmospheric air is introduced is formed in a space inside the sensor element 2 having a bottomed cylindrical shape. Meanwhile, a subject gas chamber 7 through which the exhaust gas passes is positioned outside the sensor element 2 (refer to FIG. 8(a)). A reference gas side electrode 4 facing the reference gas chamber 6 is provided on an inner surface of the sensor element 2. Also, a subject gas side electrode 5 facing the subject gas chamber 7 is provided on an outer surface of the sensor element 2. In general, these electrodes are formed from platinum or the like.

Also, a ceramic heater 8 having a rod shape is inserted, from an opening end side of the sensor element 2, into the reference gas chamber 6 positioned inside the sensor element 2 having a bottomed cylindrical shape. The ceramic heater 8 is positioned and fixed by making a peripheral edge of a lower end thereof contact an inner face of a bottom portion of the sensor element 2. The ceramic heater 8 includes a heat generation circuit 8c therein. When electric power is supplied to the heat generation circuit 8c, the ceramic heater 8 generates heat.

Next, the mechanism by which the oxygen concentration is detected by the detecting portion will be described with reference to FIG. 8. As shown in FIG. 8(a), an oxygen sensor 1 is mounted so as to protrude in an exhaust passage inside an exhaust pipe 50. Thus, the detecting portion of the oxygen sensor 1 is exposed to the exhaust gas. A detecting portion protective cover 11 is attached to an outer side of the detecting portion in order to protect the detecting portion. The detecting portion protective cover 11 has micropores through which the exhaust gas is introduced into the subject gas chamber 7. Also, atmospheric air is introduced into the reference gas chamber 6 inside the sensor element 2.

The solid electrolyte 3, which is a main component of the sensor element 2, is activated and functions as an electrolyte at a moderately high temperature. Therefore, it is necessary to heat the sensor element 2 such that the temperature thereof reaches an activation temperature quickly. The ceramic heater 8 which has been inserted and disposed in the sensor element 2 heats the sensor element 2. At this time, the heat of the ceramic heater 8 is transmitted to the sensor element 2 mainly through a portion of contact between the ceramic heater 8 and the sensor element 2.

When a difference in the oxygen partial pressure is generated between the atmospheric air in the reference gas chamber 6 positioned inside the sensor element 2 and the exhaust gas in the subject gas chamber 7 positioned outside the sensor element 2 after the temperature of the sensor element 2 has reached the activation temperature, oxygen on a side where the oxygen partial pressure is high (normally, the atmospheric air side) is ionized so as to move to a side where the oxygen partial pressure is low (normally, the exhaust gas side) through the solid electrolyte 3 (refer to FIG. 8(b)). The oxygen molecule receives a quadrivalent electron from the reference gas side electrode 4 while being ionized, and emits the quadrivalent electron while the ionized oxygen is returned to the oxygen molecule. Thus, the electron is moved from the subject gas side electrode 5 to the reference gas side electrode 4 due to the movement of the oxygen molecule. As a result, an electromotive force is generated between the electrodes.

The electromotive force is proportional to a logarithm of the oxygen partial pressure ratio. When combustion is performed using a rich air-fuel mixture containing a high concentration of fuel, hydrocarbon (HC) and carbon monoxide (CO) are contained in the exhaust gas. The HC and CO react with the oxygen due to the catalytic action of platinum on the surface of the subject gas side electrode until chemical equilibrium is achieved. As a result, when the air-fuel ratio is richer than a stoichiometric air-fuel ratio, the oxygen partial pressure on the exhaust gas side sharply decreases, and the electromotive force greatly changes, whereby it can be determined whether the air-fuel ratio is rich or lean based on the magnitude of an output voltage.

As an oxygen sensor of this type, a sensor is known, in which a catalytic layer is formed on a surface of a sensor element on which a subject gas side electrode is provided so as to cover the electrode (for example, refer to Japanese Patent Laid-Open Publication No. 1-316650). The catalytic layer is formed by impregnating a substrate made of alumina or the like with noble metal for a catalyst such as platinum. Thus, components in the exhaust gas are evenly distributed in the catalytic layer by forming the catalytic layer.

As described above, the conventional oxygen sensor is configured such that the peripheral edge of the lower end of the ceramic heater contacts the inner face of the bottom portion of the sensor element. In this case, no ingenuity is exercised in the structure of the contact portions, and the peripheral edge of the lower end of the ceramic heater is in line-contact with the inner face of the bottom portion of the sensor element, as shown in FIG. 7. In other words, only the periphery of the lower end of the ceramic heater contacts the inner face of the bottom portion of the sensor element having a spherical shape.

In the case of the oxygen sensor having such a portion of contact between the ceramic heater and the sensor element, when a thermal shock is suddenly given to the portion of contact between the ceramic heater and the sensor element, a strong stress is applied to the sensor element due to a difference in a coefficient of linear expansion or a temperature difference between the ceramic heater and the sensor element, which may cause a crack in the sensor element. As described above, it is necessary to raise the temperature of the solid electrolyte to the activation temperature in order to make the solid electrolyte function as an electrolyte. Therefore, the configuration is made such that the ceramic heater and the sensor element contact each other in order to raise the temperature of the sensor element to the activation temperature quickly using the ceramic heater. However, when the sensor element is suddenly heated, a crack in the element may be caused.

Also, while driving the vehicle, the exhaust gas constantly passes over the outer surface of the sensor element. At this time, moisture in the exhaust gas may be attached to the outer surface of the sensor element. The moisture attached to the outer surface of the sensor element sharply decreases the temperature of the sensor element, which causes a large temperature difference between a portion contacting the ceramic heater and a portion where the moisture is attached in the sensor element. This large temperature difference generates a large stress in the sensor element, which may leads to a crack in the sensor element at worst.

As described above, the thermal shock given to the sensor element may cause the crack in the sensor element in the oxygen sensor.

### SUMMARY OF THE INVENTION

Accordingly, in view of the above, it is an object of the invention to provide a structure of a gas sensor in which only a small stress is applied to a detecting element even when a thermal shock is suddenly given to the detecting element, thereby realizing a high-performance and reliable gas sensor.

A gas sensor according to an aspect of the invention includes a detecting element and a heating portion. The detecting element contains a solid electrolyte, has a cylindrical shape that is closed at one end and is opened at the other end, and includes a first contact portion that is a portion of an inner face of a bottom portion thereof. The heating portion is formed into a rod shape, is inserted and disposed in the detecting element, and includes a second contact portion at a peripheral edge of a lower portion thereof. The second contact portion comes into face-contact with the first contact portion of the detecting element.

### BRIEF DESCRIPTION OF THE DRAWINGS

FIG. 1 is a vertical sectional view showing an entire structure of an oxygen sensor according to an embodiment of the invention;

FIG. 2 is an enlarged vertical sectional view showing a structure of a detecting portion of the oxygen sensor according to the embodiment of the invention;

FIG. 3 is an exploded perspective view showing a ceramic heater used in the oxygen sensor according to the embodiment of the invention;

FIG. 4 is a diagram showing an analysis model of the detecting portion of the oxygen sensor, which is used for a simulation of a stress distribution by CAE analysis;

FIG. 5 is a diagram showing a result of a simulation in the structure of the oxygen sensor according to the embodiment of the invention;

FIG. 6 is a diagram showing a result of a simulation in a structure of an oxygen sensor according to a conventional example;

FIG. 7 is an enlarged vertical sectional view showing a structure of a detecting portion of the oxygen sensor according to the conventional example;

FIG. 8A and FIG. 8B are schematic diagrams describing a mechanism by which an oxygen concentration is detected;

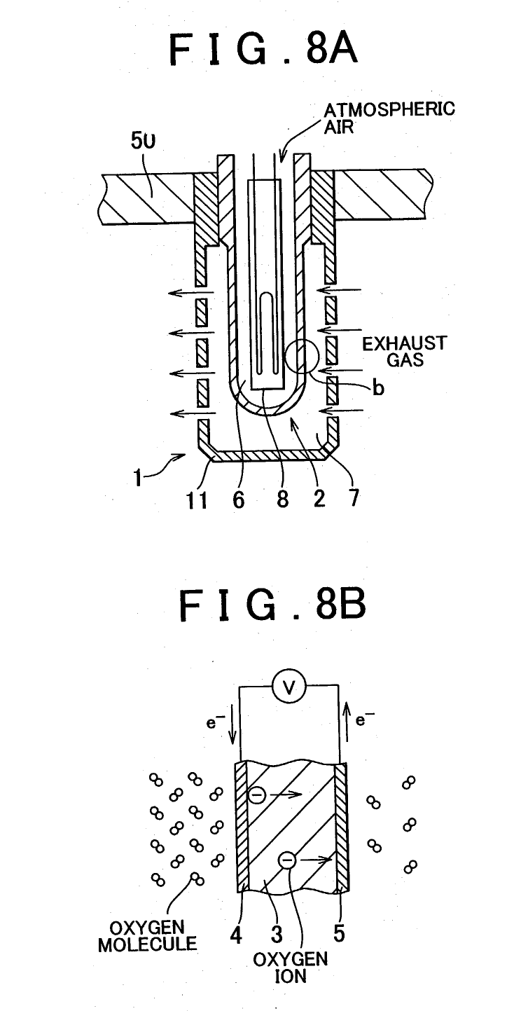

FIG. 9 is a vertical sectional view showing an entire structure of an oxygen sensor according to another embodiment of the invention; and

FIG. 10 is a vertical view showing an entire structure of an oxygen sensor according to a further embodiment of the invention.

### DETAILED DESCRIPTION OF THE PREFERRED EMBODIMENTS

Hereinafter, an embodiment of the invention will be described with reference to the accompanying drawings.

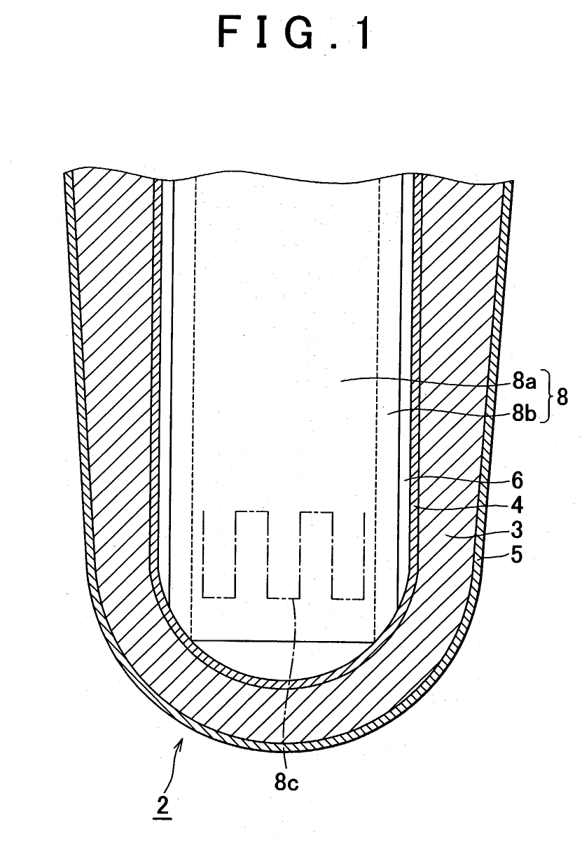

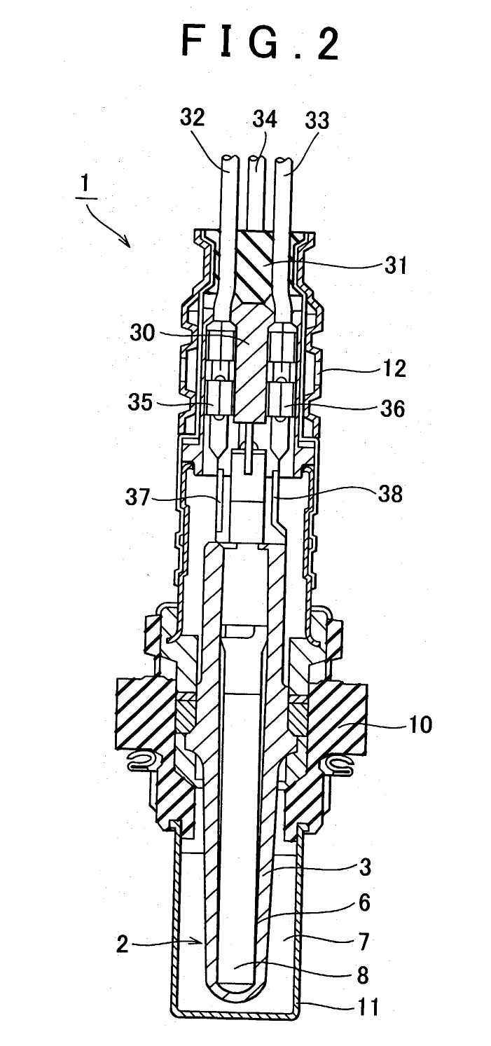

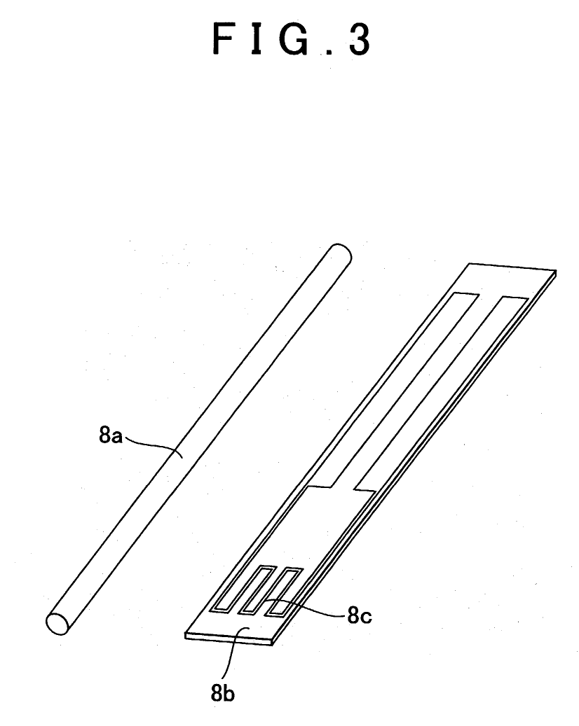

FIG. 1 is a vertical sectional view showing an oxygen sensor according to an embodiment of the invention. FIG. 2 is an enlarged vertical sectional view showing a detecting portion of the oxygen sensor shown in FIG. 1. Also, FIG. 3 is an exploded perspective view describing a structure of a ceramic heater used in the oxygen sensor according to the embodiment of the invention.

First, the entire structure of the oxygen sensor according to the embodiment will be described with reference to FIG. 2. As shown in FIG. 2, an oxygen sensor 1 includes a sensor element 2, a detecting portion protective cover 11, and a base end side cover 12. The sensor element 2 is a detecting element, and is inserted into a housing 10 so as to be fixed thereto. The detecting portion protective cover 11 is attached to an end portion side of the housing 10 so as to protect the sensor element 2. The base end side cover 12 is attached to a base end side of the housing 10.

An insulation glass 30 and a rubber bush 31 are provided inside the base end side cover 12, and plural through holes are provided in the insulation glass 30 and the rubber bush 31. Lead wires 32, 33 and a lead wire 34 pass through the through holes. The lead wires 32, 33 are electrically connected to output take-out portions 37, 38 of the sensor element 2 (described later) via connecting metal fittings 35, 36. The lead wire 34 supplies electric power to a ceramic heater 8 (described later). The output take-out portion 37 is connected to a reference gas side electrode 4 formed on an inner surface of the sensor element 2. The output take-out portion 38 is connected to a subject gas side electrode 5 formed on an outer surface of the sensor element 2.

Next, a structure of a detecting portion of the oxygen sensor will be described with reference to FIG. 1. As shown in FIG. 1, the sensor element 2 has a bottomed cylindrical shape that is closed at a lower end and is opened at an upper end. The sensor element 2 is made mainly of a solid electrolyte 3. As the solid electrolyte 3, zirconia or the like is used. A reference gas chamber 6 into which atmospheric air is introduced is formed in a space inside the sensor element 2 having a bottomed cylindrical shape. Meanwhile, a subject gas chamber 7 (refer to FIG. 1) through which an exhaust gas passes is positioned outside the sensor element 2. A reference gas side electrode 4 facing the reference gas chamber 6 is provided on an inner surface of the sensor element 2. A subject gas side electrode 5 facing the subject gas chamber 7 is provided on an outer surface of the sensor element 2. In general, these electrodes are formed from platinum or the like.

Also, a ceramic heater 8 having a rod shape is inserted, from an opening end side of the sensor element 2, into the reference gas chamber 6 positioned inside the sensor element 2 having a bottomed cylindrical shape. The ceramic heater 8 is positioned and fixed by making the peripheral edge of the lower end thereof contact an inner face of a bottom portion of the sensor element 2. The ceramic heater 8 includes a heat generation circuit 8c therein. When electric power is supplied to the heat generation circuit 8c, the ceramic heater 8 generates heat.

The peripheral edge of the lower end of the ceramic heater 8, which is a contact portion of the ceramic heater 8, is processed so as to have a shape that comes into face-contact with a predetermined portion of the inner face of the bottom portion of the sensor element 2. In other words, the peripheral edge of the lower end of the ceramic heater 8 is processed so as to have the same curvature radius as that of a contact face of the sensor element 2, which is a contact portion of the sensor element 2. Thus, in the oxygen sensor according to the embodiment, an area of contact between the ceramic heater 8 and the sensor element 2 increases to a large extent, as compared with the oxygen sensor according to the conventional example that has been described. Herein, “face-contact” signifies a state where a face is in contact with anther face such that a portion of contact therebetween has a certain width. Accordingly, in the embodiment, the contact face provided at the peripheral edge of the lower end of the ceramic heater 8 contacts a predetermined area of the inner face of the bottom portion of the sensor element 2, which has a curved shape.

The peripheral edge of the lower end of the ceramic heater 8 is processed so as to have the aforementioned shape, for example, by grinding. As shown in FIG. 3, the ceramic heater 8 is formed as follows: A heat generation circuit 8c is printed in a ceramic sheet 8b before burning, the ceramic sheet 8b is wound around a core rod 8a made of ceramic, and then the ceramic sheet 8b wound around the core rod 8a is burned. In the case where grinding is performed, the peripheral edge of the lower end of the ceramic heater 8 is processed by grinding after burning such that the peripheral edge of the lower end of the ceramic heater 8 has a predetermined shape (that is, a shape which comes into face-contact with the inner face of the bottom portion of the sensor element 2). Also, the ceramic sheet or the like may be processed into the predetermined shape in advance before burning the ceramic heater 8.

Thus, the area of contact between the ceramic element and the ceramic heater can be increased. Accordingly, it is possible to reduce a stress that is generated when a thermal shock is given to the sensor element. As a result, the rate at which a crack in the sensor element occurs is reduced to a large extent when the sensor element is heated under the same conditions as the conditions under which the conventional detecting element is heated, and accordingly the yield and the reliability are improved. Also, since the area of contact increases, the temperature of the sensor element can be raised to the activation temperature more quickly when the sensor element is heated under the same conditions as the conditions under which the conventional detecting element is heated. Thus, air-fuel ratio control can be performed quickly.

Hereinafter, a result of a simulation of a stress distribution in the sensor element when a thermal shock is given thereto.

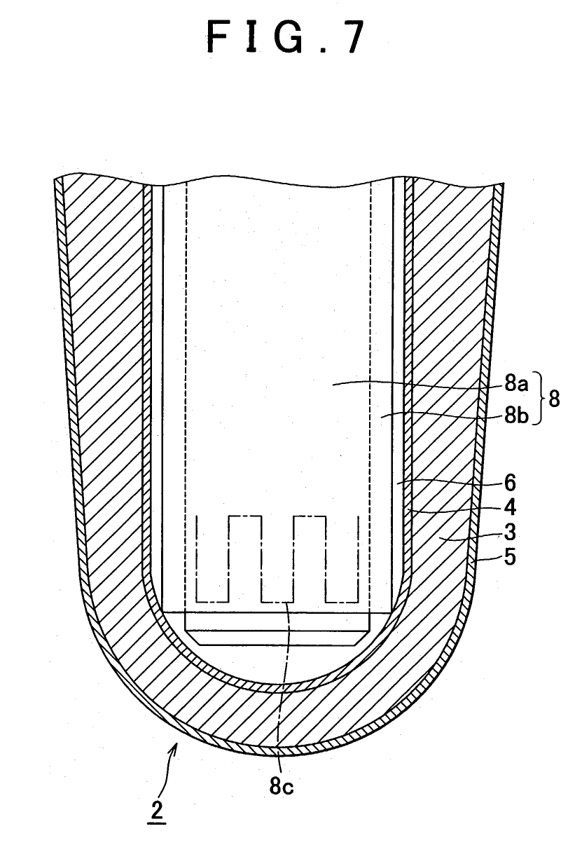

The simulation is performed by CAE analysis to simulate a thermal stress in the sensor element that is generated when moisture contained in the exhaust gas is attached to an outer surface of the sensor element whose temperature has been raised to the activation temperature. A model having the structure according to the embodiment (that is, the structure shown in FIG. 1) and a model having the structure according to the conventional example (that is, the structure shown in FIG. 7) are made as analysis models, and analyses are performed using these models under the same conditions.

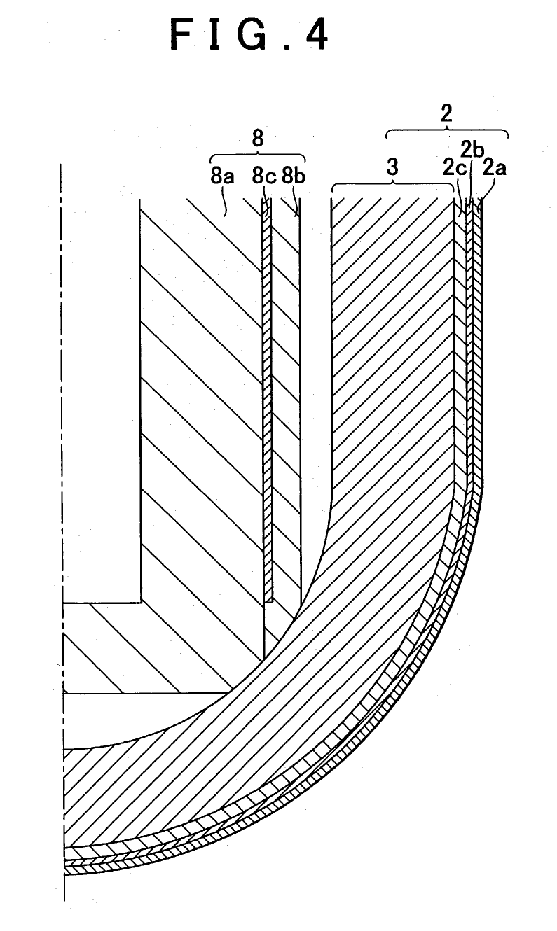

First, the structure of the sensor element will be described. A model which is an axisymmetric as shown in FIG. 4 is assumed as a model for the simulation. The model shown in FIG. 4 is the model of the oxygen sensor in the embodiment. It is assumed that plural layers are disposed in the sensor element 2. A first alumina layer 2a, a second alumina layer 2b, a spinel layer 2c, and a zirconia layer which is the solid electrolyte 3 are positioned from the outer surfaces on the both sides. Also, a reference gas side electrode and a subject gas side electrode are formed in the sensor element 8. Since these electrodes are extremely thin layers, they are omitted in the model. Meanwhile, the ceramic heater 8 includes an alumina layer which is the ceramic sheet 8b, a tungsten layer which is the heat generation circuit 8c, and an alumina layer which is the core rod 8a from the outer side.

In the aforementioned model, the number of the components is approximately 3800, and a Young's modulus, a Poisson's ratio, a thermal conductivity, a coefficient of linear expansion, a density, a specific heat, and a radiation rate are set for the component of each layer. Also, a thermal conductivity, an ambient temperature, and an initial temperature are derived based on a result of an operation test that is performed when an oxygen sensor having the same shape as that of the model is mounted in an actual vehicle. Then, the thermal conductivity, the ambient temperature, and the initial temperature are set as heat radiation conditions. Further, as thermal load conditions, a heat generation amount is constantly applied to the heat generation circuit of the ceramic heater, and an endothermic amount in the case where moisture is attached to the outer surface of the sensor element is applied to the outer surface of the sensor element for a predetermined time. Note that the activation temperature of the sensor element is set to approximately 400° C.

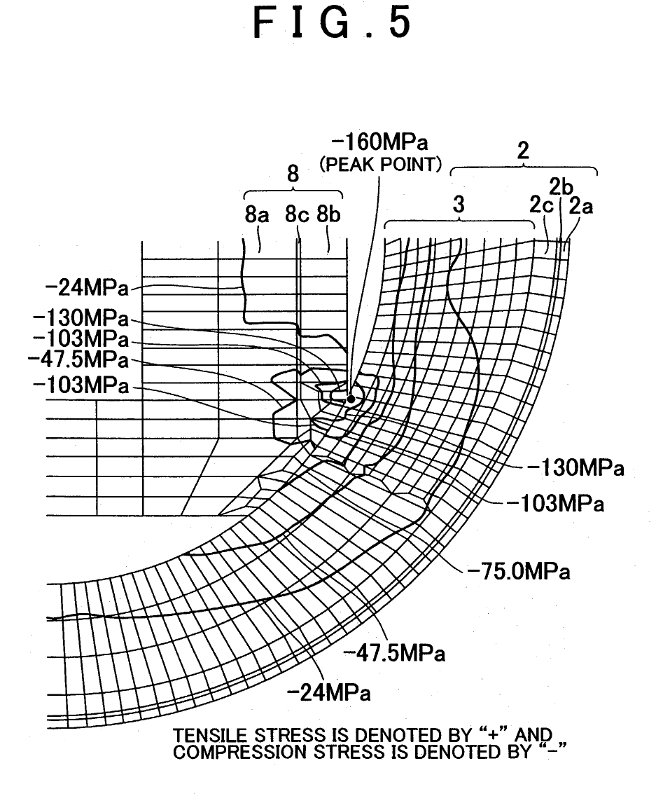

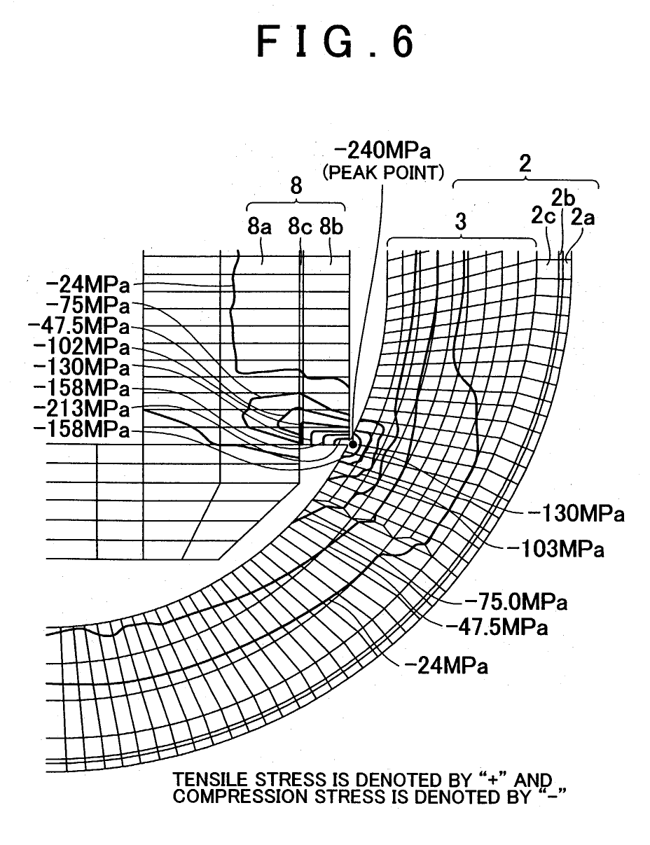

FIG. 5 and FIG. 6 show the result of the simulation that is performed under the aforementioned conditions. FIG. 5 shows the result of the simulation using the model of the oxygen sensor according to the embodiment of the invention. FIG. 6 shows the model of the oxygen sensor according to the conventional example. In each figure, a stress distribution is indicated using contour lines, a tensile stress is denoted by a symbol “+”, and a compression stress is denoted by a symbol “−”.

As shown in the figures, in each of the models, the peak of the compression stress appears in the sensor element 2 in the vicinity of a portion of contact between the sensor element 2 and the ceramic heater 8. The peak value of the compression stress is approximately 240 MPa in the model according to the conventional example, and is approximately 160 MPa in the model according to the embodiment of the invention. As apparent from the stress distribution in the sensor element 2, the stress is reduced in the model according to the embodiment, as compared with the model according to the conventional example. The stress is reduced by approximately 30% in the model according to the embodiment, as compared with the model according to the conventional example. Thus, it has been confirmed by the simulation that the invention is effective in reducing the stress in the sensor element 2.

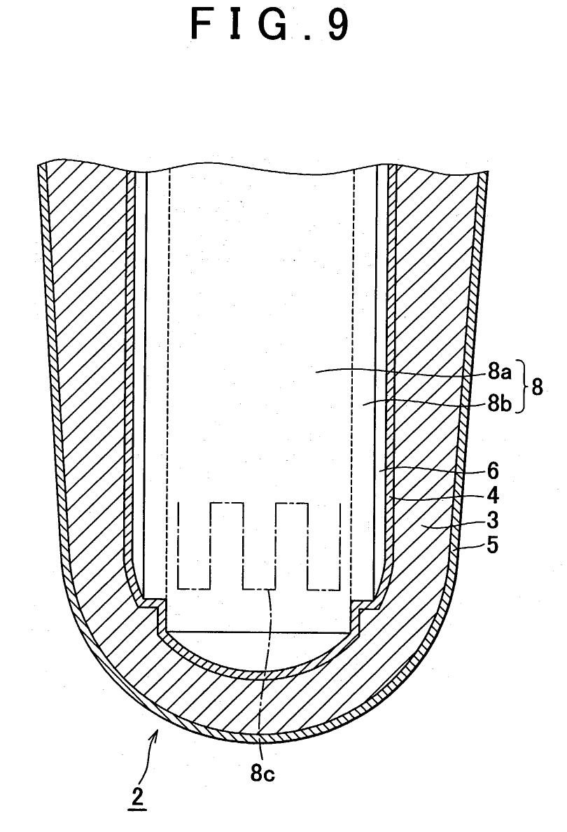

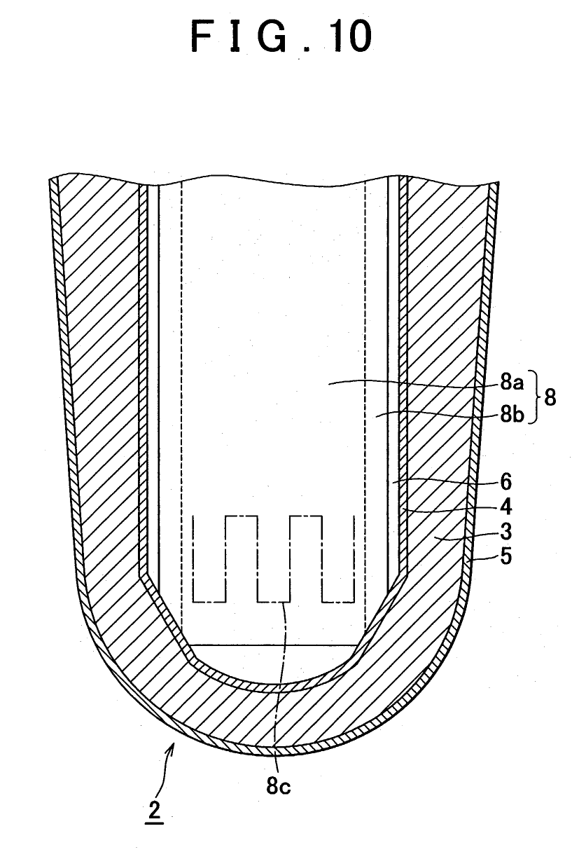

In the aforementioned embodiment, the sensor element in which the inner face of the bottom portion has a curved shape has been described as the detecting element. However, the invention is not particularly limited to this sensor element. Naturally, the invention can be applied to a detecting element in which the inner face of the bottom portion does not have a curved shape. For example, in the case where the inner face of the bottom portion of the detecting element has a stepped portion, a peripheral edge of a bottom face of a rod-shaped heating portion as heating means may come into face-contact with an upper face of the stepped portion of the detecting element (refer to FIG. 9). Also, in the case where the inner face of the bottom portion of the detecting element has a taper portion, the peripheral edge of the lower end of the heating portion may be formed into a taper shape so as to come into face-contact with a predetermined area of the taper portion of the detecting element (refer to FIG. 10). Further, the portion of contact between the detecting element and the heating portion may be of any size. Only the peripheral edge of the lower end of the heating portion may contact the detecting element, or the entire face of the lower end of the heating portion may contact the detecting element. In other words, according to the invention, the detecting element and the heating portion comes into face-contact with each other such that the portion of contact therebetween has a certain width. Therefore, the shape and the size of the portion of contact between the detecting element and the heating portion are not limited.

Also, while the ceramic heater has been described as the heating portion in the aforementioned embodiment, the invention is not particularly limited to the ceramic heater, and another heating portion may be employed. However, as described above, it is preferable to employ the ceramic heater due to the reasons that the shape of the ceramic heater can be processed easily, the ceramic heater can be manufactured at low cost, and the other reason.

Further, in the aforementioned embodiments, only the oxygen sensor that detects an oxygen concentration has been described. However, the invention can be applied to an air fuel sensor (an A/F sensor).

Thus, the embodiment of the invention that has been disclosed in the specification is to be considered in all respects as illustrative and not restrictive. The technical scope of the invention is defined by claims, and all changes which come within the meaning and range of equivalency of the claims are therefore intended to be embraced therein.

Thus, according to the embodiment of the invention, each of the contact portion of the detecting element and the contact portion of the heating portion is a contact face such that they come into face-contact with each other. Therefore, the area of contact therebetween increases. Thus, the stress that is generated when a thermal shock is given to the detecting element is reduced. As a result, the rate at which the crack in the sensor element occurs is reduced to a large extent when the sensor element is heated under the same conditions as the conditions under which the conventional detecting element is heated, and the yield and the reliability are improved.

Also, since the area of contact increases, the temperature of the sensor element can be raised to the activation temperature more quickly when the sensor element is heated under the same conditions as the conditions under which the conventional detecting element is heated. Thus, air-fuel ratio control can be performed quickly. Accordingly, it is possible to provide a gas sensor in which only a small stress is applied to the detecting element when a thermal shock is suddenly given to the detecting element, since the peripheral edge of the lower end of the heating portion comes into face-contact with the inner face of the bottom portion of the detecting element at the portion of contact therebetween.

Also, in the case where the inner face of the bottom portion of the detecting element has a curved shape, the contact portion of the heating portion is processed into a curved shape that has the same curvature radius as that of the contact portion of the detecting element, whereby the detecting element and the heating portion come into face-contact. Thus, the stress that is generated when a thermal shock is given to the detecting element is reduced, and the crack in the sensor element is prevented from occurring.

Thus, according to the invention, it is possible to provide a high-performance and reliable gas sensor.

The shape of the ceramic heater can be processed more easily as compared with other heating portions. Therefore, it is possible to process the contact portion of the heating portion into the shape that fits the shape of the detecting element by employing the ceramic heater as the heating portion used for the gas sensor. The contact portion of the ceramic heater is processed, for example, by winding a ceramic sheet around a core rod, and then grinding the peripheral edge of the lower end thereof.

What is claimed is:

1. A gas sensor comprising:
a detecting element which contains a solid electrolyte, and has a cylindrical shape that is closed at one end and is opened at the other end, and which includes a first contact portion that is a portion of an inner face of a bottom portion thereof; and
a heating portion which is formed into a rod shape, and is inserted and disposed in the detecting element, and which includes a second contact portion at a peripheral edge of a lower portion thereof, the second contact portion coming into face-contact with the first contact portion of the detecting element.

2. The gas sensor according to claim 1, wherein the heating portion is a ceramic heater that is formed by winding, around a core rod made of ceramic, a ceramic sheet in which a heat generation circuit is printed.

3. The gas sensor according to claim 1, wherein the heating portion is formed by attaching, to a core rod made of ceramic, a ceramic heater that has been processed into a predetermined shape in advance.

4. The gas sensor according to claim 1, wherein the inner face of the bottom portion of the detecting element has a curved shape, and the second contact portion of the heating portion has the same curvature radius as that of the first contact portion of the detecting element.

5. The gas sensor according to claim 4, wherein the heating portion is a ceramic heater that is formed by winding, around a core rod made of ceramic, a ceramic sheet in which a heat generation circuit is printed.

6. The gas sensor according to claim 4, wherein the heating portion is formed by attaching, to a core rod made of ceramic, a ceramic heater that has been processed into a predetermined shape in advance.

7. The gas sensor according to claim 1, wherein the inner face of the bottom portion of the detecting element has a stepped portion, the first contact portion of the detecting element is an upper face of the stepped portion, and the second contact portion of the heating portion comes into face-contact with the upper face of the stepped portion of the detecting element.

8. The gas sensor according to claim 7, wherein the heating portion is a ceramic heater that is formed by winding, around a core rod made of ceramic, a ceramic sheet in which a heat generation circuit is printed.

9. The gas sensor according to claim 7, wherein the heating portion is formed by attaching, to a core rod made of ceramic, a ceramic heater that has been processed into a predetermined shape in advance.

10. The gas sensor according to claim 1, wherein the first contact portion of the detecting element has a taper shape, and the second contact portion of the heating portion has a taper shape having the same angle as that of the first contact portion of the detecting element.

11. The gas sensor according to claim 10, wherein the heating portion is a ceramic heater that is formed by winding, around a core rod made of ceramic, a ceramic sheet in which a heat generation circuit is printed.

12. The gas sensor according to claim 10, wherein the heating portion is formed by attaching, to a core rod made of ceramic, a ceramic heater that has been processed into a predetermined shape in advance.
